(19) United States
(12) Patent Application Publication
(10) Pub. No.: US 2009/0190344 A1
(43) Pub. Date: Jul. 30, 2009

(54) Multi-Spectral UV IIluminator

(75) Inventors: Wayne Worthington, Granbury, TX (US); Mark Siegel, Fort Worth, TX (US)

Correspondence Address: MARK RODGERS, 1590 SAN ROQUE ROAD, SANTA BARBARA, CA, 93105, US

(73) Assignee: WeScanIDs LLC

(21) Appl. No.: 12/011,795

(22) Filed: Jan. 29, 2008

(51) Int. Cl. F21S 10/02

(52) U.S. Cl. 362/231; 315/322

(57) ABSTRACT

A multi-spectral Ultraviolet (UV) illuminator is described. The illuminator allows for the convenient reading of authentication patterns formed by UV inks. The novel illuminator is usable with inks of different spectral responses, allowing for reading many types of patterns with one device. The illuminator further provides the capability of producing multiple UV frequency illumination sequences, allowing for more complex, harder-to-counterfeit, authentication markings, such as animated patterning.

### RELATED APPLICATIONS

Not Applicable

### FEDERALLY SPONSORED RESEARCH

Not Applicable

### SEQUENCE LISTING

Not Applicable

### BACKGROUND OF THE INVENTION

This invention relates to the illumination at multiple spectral frequencies of Ultraviolet (UV) reactive patterns. The invention is particularly applicable to illumination of authentication patterns formed by UV inks.

Ultra-Violet marking for identification or authentication has been in use for many years. Examples are UV hand-stamps, patterns formed by UV inks on Identification documents such as drivers licenses and passports, and patterns formed by UV inks on currency or tickets. The technology to view these patterns has, to date, primarily been Florescent or Mercury Vapor Backlighting. The manufacturers of UV reactive Inks and Dyes have tailored their products to the frequency of operation of the backlight devices. Most Inks and Dyes are in either the 365 nm or 395 nm optical frequency range. UV light sources are typically very High Q devices. So a light source in the 395 nm range will get no reaction from an Ink in the 365 nm range. Marking systems currently select a frequency, and both ink and light source are mated for use.

Thus general purpose illuminators for UV authentication are not currently available, primarily due to the lack of multi-spectral illuminators. The few UV multi-spectral illuminators that are known to the inventors are generally limited to providing only a single spectral frequency illumination at any one time, and require re-configuration to change frequencies. Such devices are not suitable to most identification pattern authentication applications. For instance, a performance venue such as a nightclub may take tickets, receive currency, and check ID documents, such as drivers licenses for age verification. Each of these may use a different UV ink with a different spectral response. Currently the venue could possibly require three different UV illuminator types. Moreover the current requirement to match ink with illuminator limits the complexity of patterning and therefore produces patterns which are easier to counterfeit. It is the object of this invention to address many of the current limitations in the reading of UV ink authentication patterning.

### BRIEF SUMMARY OF THE INVENTION

The invention in one embodiment is an ultraviolet illuminator including a first ultraviolet LED adapted to emit at a first spectral frequency, and at least a second ultraviolet LED adapted to emit at second spectral frequency. The invention also includes a controller adapted to independently turn the LED's on and off, whereby the illuminator is made to illuminate an object in any combination of one spectral frequency at a time, multiple spectral frequencies simultaneously or a predetermined sequence of on/off periods of each spectral frequency. In a particular version, the first and second LED's emit at two different spectral frequencies chosen from the group of 365 nm, 385 nm or 395 nm.

In another version, the illuminator includes a third ultraviolet LED emitting at a third spectral frequency. In a particular variant of this version, the first, second, and third LED's emit at three different spectral frequencies chosen from the group of 365 nm, 385 nm or 395 nm.

In a preferred embodiment, the illuminator is configured as a lighted magnifier, with the LED's optically disposed to illuminate the focal point of the magnifier.

In another embodiment, the invention is a method of identification of a pattern formed from ultraviolet reactive inks, including the steps of illuminating the pattern with a source of multi spectral UV light and, causing the source to emit in any combination of one spectral frequency at a time, multiple spectral frequencies simultaneously or a predetermined sequence of on/off periods of spectral frequencies.

### BRIEF DESCRIPTION OF THE DRAWINGS

The invention will be better understood by referring to the following figures.

FIG. 1 shows the spectral illumination achievable with separate sources

FIG. 2 shows schematically an embodiment of the invention.

FIG. 3 shows the resultant spectral illumination achievable with the invention.

FIG. 4 shows a unique application of the invention.

FIG. 5 depicts a preferred embodiment of the invention

### DETAILED DESCRIPTION OF THE INVENTION

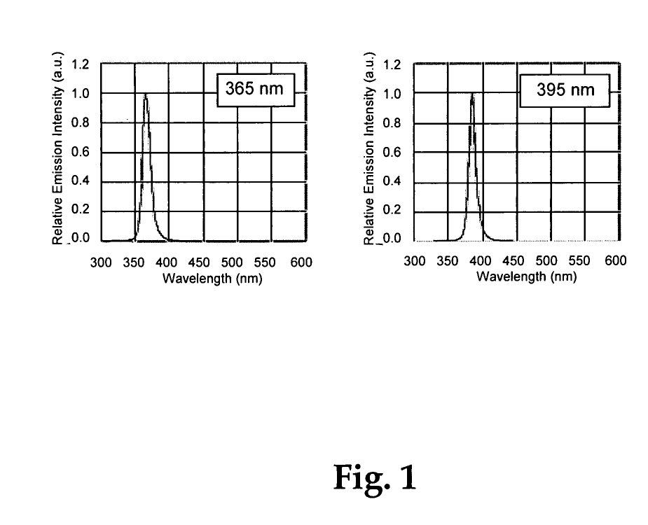

Currently UV illumination is generally, at least in any form suitable for authenticating documents such as currency or tickets at the time of use, only available in single very narrow spectral bands. For instance as shown in FIG. 1, a source may be available with a center frequency of 365 nm and another source may be available at 395 nm. As shown in the Figure, typical UV sources are sufficiently high Q, that the intensity of a 365 nm source at 395 nm, and vice versa, is very low. Accordingly UV surface treatments such as inks or dies that fluoresce at a particular wavelength can only be excited by a source that emits that wavelength.

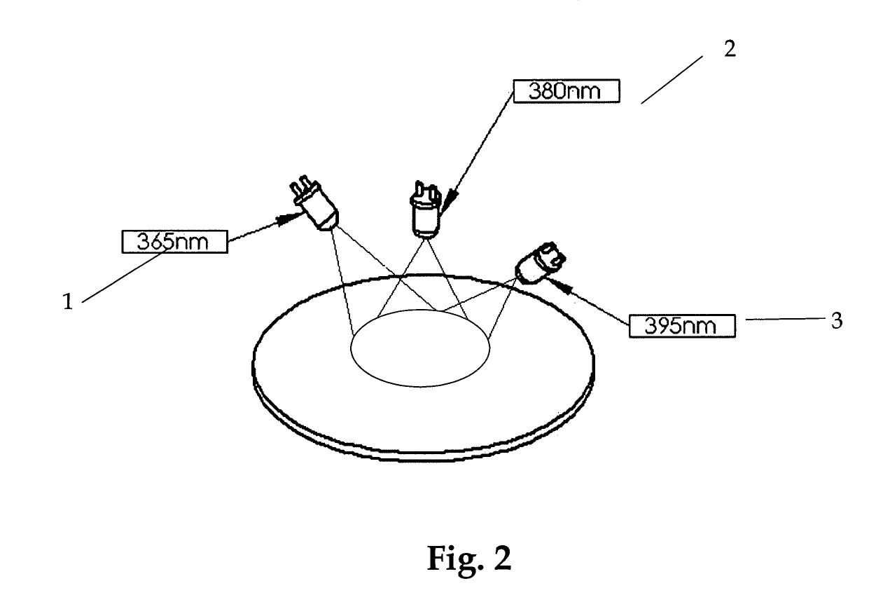

Thus a multi-spectral source is required to read inks of different types. A particularly convenient approach to a multi-spectral UV source is an embodiment of the invention. UV Light Emitting Devices (LED'S) have recently become available in specifiable peak wavelengths. Referring to FIG. 2, a multi-spectral UV source can be created by building an illuminator of LED's specified for peak emission at wavelengths corresponding to the fluorescent response wavelengths of common UV inks. The most common inks fluoresce at 365 nm, shown at 1 in the figure, and 395 nm, shown at 3. Less common, but sometimes encountered are inks that fluoresce at 380 nm, as shown at 3. Thus a useful illuminator could be made with two LED's or sets of LED's at 365 nm and 395 nm, or with three LED's (or sets of LED's) as shown. Obviously, more than three wavelengths could be accommodated if desired by adding other peak emission LED's

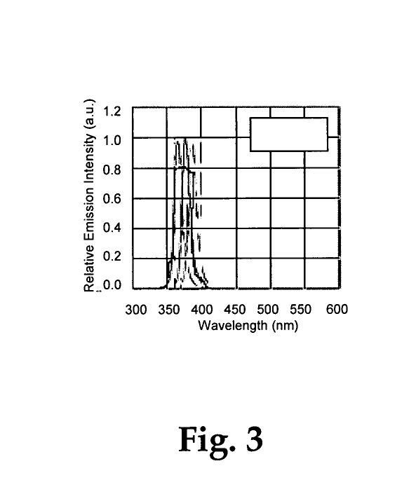

The result as shown in FIG. 3 is an illuminator that covers a range of wavelength suitable for most UV inks.

Not shown, in the figures, as such devices are known in the art, is a controller that is capable of turning on the LED's independently from each other, in a fashion that allows for any predetermined combinations or sequences of illumination to occur Two examples follow:

Mode 1: All frequencies on simultaneously: In this mode any ink or dye that is sensitive to the frequencies included will become visible.

Example: Three LED frequencies: 365 nm, 380 nm, and 395 nm.
Currency with 365 nm Ink: becomes visible
Driver License 395 nm Ink: Becomes visible
Stock Certificate 380 nm Dye: Becomes visible
Special Security Card: 365 nm Dye and 380 nm Ink: Becomes visible
Show Ticket: 395 nm Dye and 380 nm Dye: Becomes visible,

The above operation preferably happens with the push of a single button. The user does not need to know anything about the technology to use the device, thus making it practical for uses such as ticket checking, currency authentication and the like.

With devices currently available that provide multi-spectral UV illumination, an expert in forensic analysis would need to find the correct frequency for the item to be examined and program the unit for the required light source.

Mode 2: The various spectral frequencies are turned on and off in a pre-determined pattern. For example, frequencies could be cycled through in a rotational manor, with a frequency to frequency timing to less then 66 mS, in either circular switching or pendulum switching.

### Circular: 1,2,3,4->1,2,3,4->etc

### Pendulum: 1,2,3,4->3,2,1->2,3,4->etc

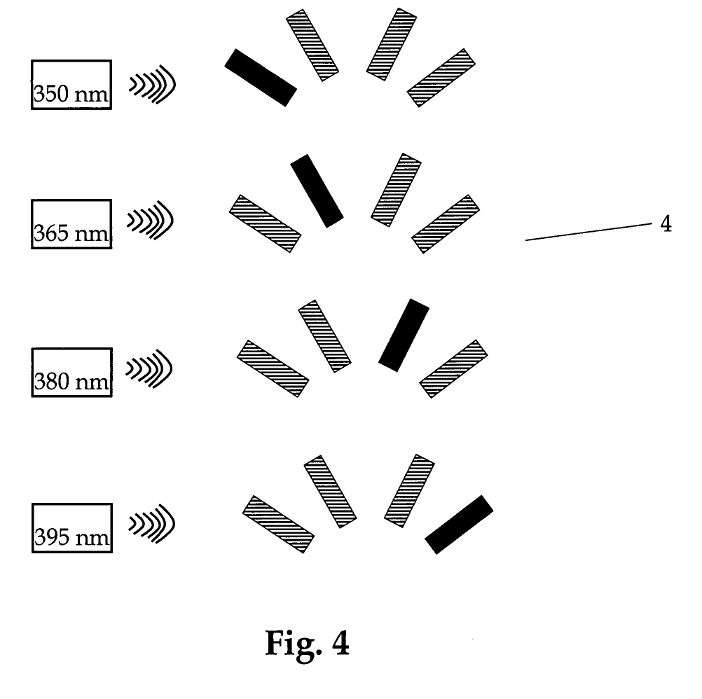

An example is shown in FIG. 4. Four LED frequencies 350 nm, 365 nm, 380 nm, and 395 nm may be disposed to illuminate a pattern, where individual elements in the pattern 4 fluoresce at one of the frequencies, as shown in the figure. In this case if the sources are cycled rotationally, the pattern 4 when cycled through produces an animated spinning line. Most markings can be animated by using standard animation techniques understood in the art. Pattern selecting could easily be changed in a suitably constructed illuminator, by labeled buttons or rotary switch selections for specific types of documents. The patterns could be preprogrammed into the controller.

Thus in mode 1, one device can be used to read practically any UV authentication marking. Mode 2 however, enables more complex marking patterns, which would be much harder to counterfeit.

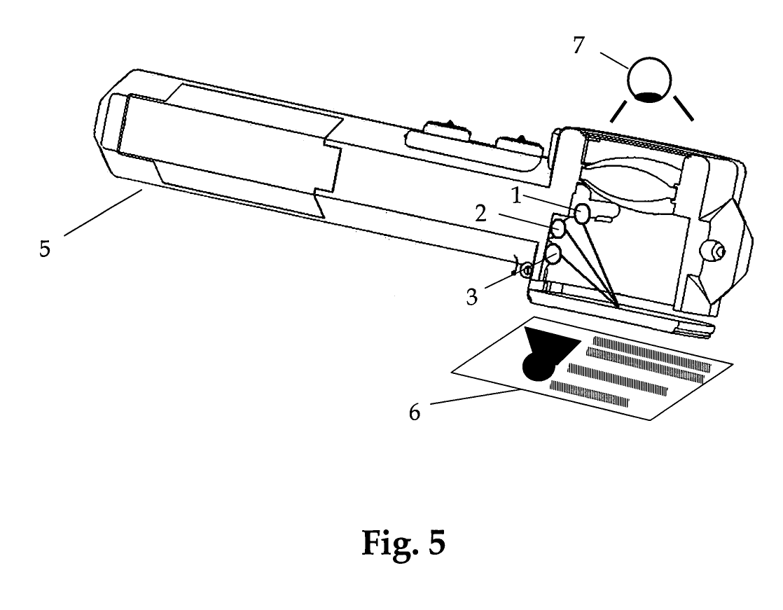

A preferred embodiment, useful for many applications, is handheld, preferably battery-powered, lighted magnifier, as shown in FIG. 5. LED's 1, 2 and 3, are disposed optically, as known in the art, to illuminate the focal point of magnifier 5. UV pattern five 6 is observed by eye 7 though the magnifier. As UV light frequencies are very dangerous, it is important for such a device to be constructed and operated appropriately. At lower frequencies UV light can cause sunburn to the skin and to the eyes cataracts and cancer. At higher frequencies UV light kills bacteria and can cause cellular destruction and blindness very quickly. For safety reasons all optical viewing ports must be coated with UV filtering. In addition the viewing stage should have a guard to eliminate extraneous UV light from escaping the magnifying chamber. It is also desirable that all activation methods be momentary so that the UV lights can not be activated without human intervention.

We claim:

1. An ultraviolet illuminator, comprising;
a first ultraviolet LED adapted to emit at a first spectral frequency,
at least a second ultraviolet LED adapted to emit at second spectral frequency; and,
a controller adapted to independently turn the LED's on and off, whereby the illuminator is made to illuminate an object in any combination of one spectral frequency at a time, multiple spectral frequencies simultaneously or a predetermined sequence of on/off periods of each spectral frequency.

2. The illuminator of claim 1 further comprising a third ultraviolet LED emitting at a third spectral frequency.

3. The illuminator of claim 1 wherein the first and second LED's emit at two different spectral frequencies chosen from the group of 365 nm, 380 nm or 395 nm.

4. The illuminator of claim 2 wherein the first, second, and third LED's emit at three different spectral frequencies chosen from the group of 365 nm, 385 nm or 395 nm.

5. The illuminator of claim 1 wherein the illuminator is configured as a lighted magnifier, with the LED's optically disposed to illuminate the focal point of the magnifier.

6. A method of identification of a pattern formed from ultraviolet reactive surface treatments comprising,
illuminating the pattern with source of multi spectral UV light; and,
causing the source emit in any combination of one spectral frequency at a time, multiple spectral frequencies simultaneously or a predetermined sequence of on/off periods of spectral frequencies.
